(19) United States
(12) Patent Application Publication
(10) Pub. No.: US 2014/0147357 A1
(43) Pub. Date: May 29, 2014

(54) COMPOSITION CONSISTING OF A ZIRCONIA-CERIA MIXED OXIDE WITH INCREASED REDUCIBILITY, PRODUCTION METHOD AND USE IN THE FIELD OF CATALYSIS

(71) Applicants: Simon Ifrah, La Jarrie (FR); Lama Itani, Savigny-Sur-Orge (FR); Julien Hernandez, Antony (FR); Dominique Horbez, Franconville (FR)

(72) Inventors: Simon Ifrah, La Jarrie (FR); Lama Itani, Savigny-Sur-Orge (FR); Julien Hernandez, Antony (FR); Dominique Horbez, Franconville (FR)

(73) Assignee: Rhodia Operations, Aubervilliers (FR)

(21) Appl. No.: 14/130,906

(22) PCT Filed: Jun. 25, 2012
(86) PCT No.: PCT/EP2012/062224

§ 371 Date: Jan. 17, 2014

(30) Foreign Application Priority Data
Jul. 4, 2011 (FR) 11/02090

(51) Int. Cl. B01J 23/10; B01D 53/94

(52) U.S. Cl. CPC B01J 23/10; B01D 53/945
USPC 423/213.2; 502/304

(57) ABSTRACT

The invention relates to a composition essentially consisting of a zirconia-ceria mixed oxide, with a zirconia content of at least 40 wt. % and, after 4 hours of calcination at 1000° C., a specific surface area of at least 25 m²/g and a quantity of mobile oxygen between 200° C. and 400° C. of at least 0.5 ml O₂/g. Said composition is produced using a method wherein a mixture of cerium and zirconium compounds is continuously reacted with a basic compound in a reactor, with a maximum residence time of the reactive medium in the mixture zone of the reactor of 100 milliseconds; and the precipitate is heated then brought into contact with a surfactant before being calcinated.

The present invention relates to a composition consisting of a mixed oxide of zirconium and cerium, with high reducibility, to the process for preparing it and to its use in the field of catalysis.

“Multifunctional” catalysts are currently used for the treatment of exhaust gases from internal combustion engines (motor vehicle afterburning catalysis). The term “multifunctional” is understood to mean catalysts capable of carrying out not only oxidation, in particular of carbon monoxide and hydrocarbons present in exhaust gases, but also reduction, in particular of nitrogen oxides also present in these gases (“three-way” catalysts). Products based on cerium oxide, zirconium oxide and optionally one or more oxides of other rare-earth metals appear today as particularly important and advantageous constituents included in the composition of catalysts of this type. To be effective, these constituents must have a high specific surface area even after having been subjected to high temperatures, for example of at least 900° C.

Another quality required for these catalyst constituents is reducibility. The term “reducibility” means here, and for the rest of the description, the capacity of the catalyst to be reduced under a reductive atmosphere and to be reoxidized under an oxidizing atmosphere. The reducibility may be measured especially by the amount of mobile oxygen or of labile oxygen per unit mass of the material and for a given temperature range. This reducibility and, consequently, the efficacy of the catalyst are maximal at a temperature which is currently quite high for catalysts based on the abovementioned products. Now, there is a need for catalysts whose performance qualities are sufficient in lower temperature ranges.

In the current state of the art, it appears that the two characteristics mentioned above are often difficult to reconcile, i.e. high reducibility at a lower temperature has as a counterpart a rather low specific surface area.

The object of the invention is to provide a composition of this type which has in combination a high specific surface area and good reducibility at a lower temperature.

With this aim, the composition of the invention consists essentially of a mixed oxide of zirconium and cerium, with a zirconium oxide content of at least 45% by mass, and it is characterized in that it has, after calcination at 1000° C. for 4 hours, a specific surface area of at least 25 m²/g and an amount of oxygen that is mobile between 200° C. and 400° C. of at least 0.5 ml O₂/g.

Other features, details and advantages of the invention will become even more fully apparent on reading the description which follows, given with reference to the attached drawings, in which:

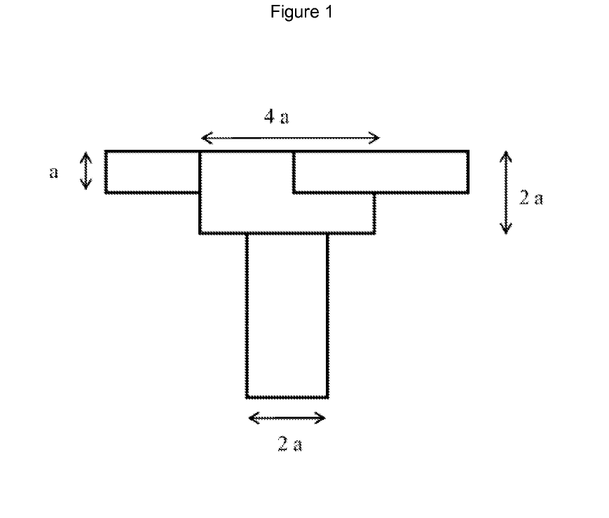

FIG. 1 is a scheme of a reactor used for performing the process for preparing the composition of the invention;

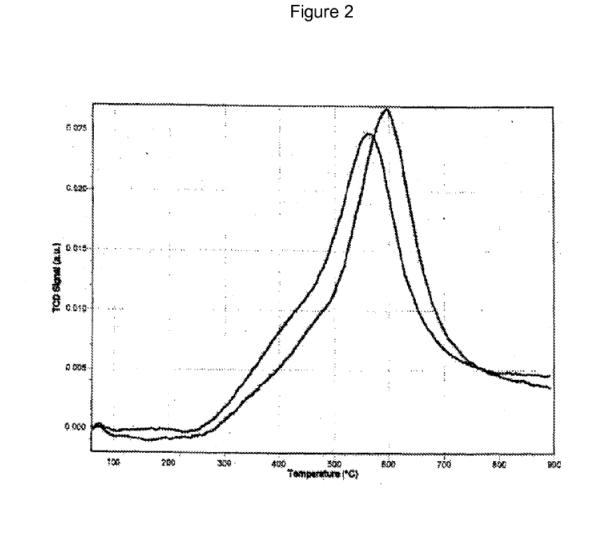

FIG. 2 shows the curves obtained by a measurement of reducibility by temperature-programmed reduction of a composition according to the invention and of a comparative product.

For the continuation of the description, the term “specific surface area” is understood to mean the BET specific surface area determined by nitrogen adsorption in accordance with the standard ASTM D 3663-78 drawn up from the Brunauer-Emmett-Teller method described in the periodical “The Journal of the American Chemical Society”, 60, 309 (1938).

In addition, the calcinations and especially the calcinations after which the surface area values are given are calcinations in air at a temperature steady stage over the indicated period, unless otherwise mentioned.

The contents or amounts are given as mass of oxide relative to the entire composition, unless otherwise mentioned. The cerium oxide is in ceric oxide form.

It is specified, for the continuation of the description, that, unless otherwise indicated, in the ranges of values which are given, the values at the limits are included.

The amount of mobile or labile oxygen corresponds to half of the molar amount of hydrogen consumed by reduction of the oxygen of the composition to form water and measured between different temperature limits, between 200° C. and 450° C. or even between 200 and 400° C. This measurement is performed by temperature-programmed reduction on an Autochem II 2920 machine with a silica reactor. Hydrogen is used as reducing gas at 10% by volume in argon with a flow rate of 30 mL/minute. The experimental protocol consists in weighing out 200 mg of the sample in a pre-tared container. The sample is then introduced into a quartz cell containing quartz wool in the bottom. The sample is finally covered with quartz wool, placed in the oven of the measuring machine, and a thermocouple is placed at the core of the sample. A signal is detected with a thermal conductivity detector. Hydrogen consumption is calculated from the missing surface area of the hydrogen signal between 200° C. and 450° C. or even between 200° C. and 400° C.

The maximum reducibility temperature (temperature at which the uptake of hydrogen is maximal and at which, in other words, the reduction of cerium IV to cerium III is also maximal and which corresponds to maximum O₂ lability of the composition) is measured by performing a temperature-programmed reduction, as described above. This method makes it possible to measure the hydrogen consumption of a composition according to the invention as a function of the temperature and to deduce therefrom the temperature at which the degree of cerium reduction is maximal.

The reducibility measurement is performed by temperature-programmed reduction on a sample that has been calcined beforehand for 4 hours at 1000° C. in air. The temperature rise takes place from 50° C. to 900° C. at a rate of 10° C./minute. The hydrogen uptake is calculated from the missing surface area of the hydrogen signal from the baseline at room temperature to the baseline at 900° C.

The maximum reducibility temperature is reflected by a peak on the curve obtained via the temperature-programmed reduction method that has been described. It should be noted, however, that in certain cases such a curve may comprise two peaks.

The compositions according to the invention are characterized first of all by the nature of their constituents.

These compositions consist essentially of a mixed oxide or a mixture of oxides of zirconium and cerium.

The zirconium oxide content is at least 45%. It may more particularly be at least 60% and even more particularly at least 70%. This value may more particularly be not more than 95% and even more particularly not more than 90%.

According to a variant of the invention, the compositions of the invention may also contain one or more additional elements that may be chosen from the group consisting of iron, cobalt, strontium, copper and manganese. This or these additional elements are generally present in oxide form. In the case of this variant, the compositions of the invention then consist essentially of a mixed oxide or a mixture of oxides of zirconium and cerium and of one or more abovementioned additional elements. The amount of additional element is generally not more than 10%, and it may more particularly be between 2% and 8%.

The term “consist essentially” means that the compositions may comprise other elements in the form of traces or impurities, especially such as hafnium, but that they do not comprise other elements that are especially liable to have an influence on their specific surface area and/or their reducibility properties. In particular, the compositions of the invention do not contain any rare-earth metals other than cerium.

The compositions of the invention have the characteristic of having a substantial amount of mobile oxygen in a relatively low temperature range. This amount expressed in ml of oxygen per gram of composition is at least between 0.5 ml O₂/g between 200° C. and 400° C. This amount may especially be at least 0.6 ml O₂/g. Amounts of up to about at least 1 ml O₂/g may be reached.

In a slightly wider temperature range, i.e. between 200° C. and 450° C., the compositions of the invention have an amount of mobile oxygen of at least 0.9 ml O₂/g and more particularly of at least 1 ml O₂/g. Amounts of up to about at least 1.5 ml O₂/g may be reached.

Another feature of the compositions of the invention is that they have, after calcination at 1000° C. for 4 hours, a maximum reducibility temperature of not more than 580° C. and more particularly of not more than 570° C. This maximum reducibility temperature may especially be at least 530° C.

The compositions of the invention also have particular specific surface area characteristics. Specifically, while at the same time having good reducibility properties at low temperature, they also offer high specific surface areas even at high temperatures.

Thus, they have, after calcination at 1000° C. for 4 hours, a specific surface area of at least 25 m²/g, more particularly of at least 30 m²/g and even more particularly of at least 35 m²/g. Under these same calcination conditions, specific surface areas up to a value of about 45 m²/g may be obtained.

Moreover, these compositions have, after calcination at 1100° C. for 4 hours, a specific surface area of at least 8 m²/g, more particularly of at least 10 m²/g and even more particularly of at least 12 m²/g. Under these same calcination conditions, specific surface areas up to a value of about 20 m²/g may be obtained.

Another advantageous characteristic of the compositions of the invention is that they may be in the form of deaggregatable particles. Thus, via a simple ultrasonication treatment, these particles may have, after such a treatment and irrespective of the starting particle size, a mean diameter (d₅₀) of not more than 10 μm, more particularly not more than 8 μm and even more particularly not more than 6 μm.

The particle sizes given here, and for the remainder of the description, are measured by means of a Malvern Mastersizer 2000 laser particle size analyzer (HydroG module) on a sample of particles dispersed in a solution containing 1 g/l of hexamethyl phosphate (HMP) and subjected to ultrasound (120 W) for 5 minutes.

The compositions of the invention may be in the form of a pure solid solution of cerium oxide and zirconium oxide. This means that cerium is present totally in solid solution in the zirconium oxide. The X-ray diffraction diagrams of these compositions in particular reveal, in these compositions, the existence of a clearly identifiable single phase corresponding to that of a crystalline zirconium oxide in the quadratic system, thus reflecting the incorporation of cerium into the crystal lattice of the zirconium oxide, and thus the production of a true solid solution. It should be noted that the compositions of the invention may have this solid solution characteristic even after calcination at high temperature, for example at least 1000° C. for 4 hours.

The process for preparing the compositions of the invention will now be described. This process may be performed according to two variants as a function of the type of reactor used.

According to a first variant, the process is characterized in that it comprises the following steps:
(a) a liquid mixture is formed comprising compounds of cerium, of zirconium and, optionally, of the additional element;
(b) said mixture is reacted continuously in a reactor with a basic compound, the residence time of the reaction medium in the mixing zone of the reactor being not more than 100 milliseconds, via which a precipitate is obtained at the reactor outlet;
(c) said precipitate is heated in aqueous medium, the medium being maintained at a pH of at least 5;
(d) an additive chosen from anionic surfactants, nonionic surfactants, polyethylene glycols, carboxylic acids and salts thereof, and surfactants of the carboxymethylated fatty alcohol ethoxylate type is added to the precipitate obtained in the preceding step;
(e) the precipitate thus obtained is calcined.

According to a second variant, the process of the invention is characterized in that it comprises the following steps:
(a′) a liquid mixture is formed comprising compounds of cerium, of zirconium and, optionally, of the additional element;
(b′) said mixture is reacted continuously in a centrifugal reactor with a basic compound, the residence time of the reaction medium in the mixing zone of the reactor being not more than 10 seconds, via which a precipitate is obtained at the reactor outlet;
(c′) said precipitate is heated in aqueous medium, the medium being maintained at a pH of at least 5;
(d′) an additive chosen from anionic surfactants, nonionic surfactants, polyethylene glycols, carboxylic acids and salts thereof, and surfactants of the carboxymethylated fatty alcohol ethoxylate type is added to the precipitate obtained in the preceding step;
(e′) the precipitate thus obtained is calcined.

The difference between the two process variants lies in steps (b) and (b′). The other process steps are identical for the two variants. As a result, the description that will be given hereinbelow for steps (a), (c), (d) and (e) of the first variant similarly applies to steps (a′), (c′), (d′) and (e′) of the second variant.

The first step (a) of the process thus consists in preparing a mixture in liquid medium of the compounds of the constituent elements of the composition, i.e. cerium, zirconium and, optionally, the additional element.

The mixing is generally carried out in a liquid medium which is preferably water.

The compounds are preferably soluble compounds. They can in particular be salts of zirconium and cerium. In the case of the preparation of compositions comprising one or more additional elements of the abovementioned type, the starting mixture will also comprise a compound of this or these additional elements.

These compounds may be chosen from nitrates, sulfates, acetates, chlorides and ceric ammonium nitrate.

Mention may thus be made, as examples, of zirconium sulfate, zirconyl nitrate or zirconyl chloride. Zirconyl nitrate is most generally used. Mention may also be made especially of cerium IV salts, for instance nitrates or ceric ammonium nitrate, which are particularly suitable for use herein. Ceric nitrate is preferably used. It is advantageous to use salts with a purity of at least 99.5% and more particularly of at least 99.9%. An aqueous ceric nitrate solution may be obtained, for example, by reacting nitric acid with a hydrated ceric oxide prepared in a conventional manner by reacting a solution of a cerous salt, for example cerous nitrate, and an ammonia solution in the presence of hydrogen peroxide. Use may also be made, preferably, of a ceric nitrate solution obtained according to the process of electrolytic oxidation of a cerous nitrate solution as described in document FR-A-2 570 087, and which constitutes herein an advantageous starting material.

It will be noted here that the aqueous solutions of cerium salts and of zirconyl salts may have a certain initial free acidity, which may be adjusted by adding a base or an acid. It is, however, equally possible to use an initial solution of zirconium and cerium salts effectively having a certain free acidity as mentioned above, or solutions that have been more or less rigorously neutralized beforehand. This neutralization may be performed by adding a basic compound to the abovementioned mixture so as to limit this acidity. This basic compound may be, for example, an ammonia solution or even a solution of alkali metal (sodium, potassium, etc.) hydroxides, but preferably an ammonia solution.

Finally, it will be noted that, when the starting mixture comprises cerium in III form, it is preferable to involve an oxidizing agent, for example hydrogen peroxide, in the course of the process. This oxidizing agent may be used by being added to the reaction mixture during step (a), during step (b) or at the start of step (c).

The mixture may be obtained, indiscriminantly, either from compounds that are initially in the solid state, which will be subsequently introduced into a water feedstock, for example, or directly from solutions of these compounds followed by mixing, in any order, of said solutions.

In the second step (b) of the process, said mixture is placed in contact with a basic compound in order to cause them to react. Use may be made, as base or basic compound, of the products of the hydroxide type. Mention may be made of alkali metal or alkaline earth metal hydroxides. Use may also be made of secondary, tertiary or quaternary amines. However, the amines and ammonia may be preferred insofar as they reduce the risks of contamination by alkali metal or alkaline earth metal cations. Mention may also be made of urea. The basic compound can more particularly be used in the form of a solution.

The reaction between the starting mixture and the basic compound takes place continuously in a reactor. This reaction thus takes place by continuously introducing the reagents and also continuously removing the reaction product.

The reaction should take place under conditions such that the residence time of the reaction medium in the mixing zone of the reactor is not more than 100 milliseconds. The term “mixing zone of the reactor” means the part of the reactor in which the abovementioned starting mixture and the basic compound are placed in contact in order for the reaction to take place. This residence time may be more particularly not more than 50 milliseconds, and it may preferably be not more than 20 milliseconds. This residence time may be, for example, between 10 and 20 milliseconds.

Step (b) is preferably performed by using a stoichiometric excess of basic compound to ensure a maximum precipitation yield.

The reaction preferably takes place with vigorous stirring, for example under conditions such that the reaction medium is in a turbulent regime.

The reaction generally takes place at room temperature.

A reactor of rapid mixer type may be used.

The rapid mixer may be chosen in particular from symmetrical T-shaped or Y-shaped mixers (or tubes), asymmetrical T-shaped or Y-shaped mixers (or tubes), tangential-jet mixers, Hartridge-Roughton mixers or vortex mixers.

Symmetrical T-shaped or Y-shaped mixers (or tubes) generally consist of two opposing tubes (T-shaped tubes) or two tubes forming an angle of less than 180° (Y-shaped tubes), of the same diameter, discharging into a central tube, the diameter of which is identical to or greater than that of the two preceding tubes. They are said to be “symmetrical” because the two tubes for injecting the reactants exhibit the same diameter and the same angle with respect to the central tube, the device being characterized by an axis of symmetry. Preferably, the central tube has a diameter approximately twice as large as the diameter of the opposing tubes; similarly, the fluid velocity in the central tube is preferably equal to half that in the opposing tubes.

However, it is preferable to employ, in particular when the two fluids to be introduced do not have the same flow rate, an asymmetrical T-shaped or Y-shaped mixer (or tube) rather than a symmetrical T-shaped or Y-shaped mixer (or tube). In the asymmetrical devices, one of the fluids (generally the fluid with the lower flow rate) is injected into the central tube by means of a side tube of smaller diameter. The latter forms an angle generally of 90° with the central tube (T-shaped tube); this angle may be other than 90° (Y-shaped tube), giving cocurrent systems (for example an angle of 45°) or countercurrent systems (for example an angle of 135°), relative to the other current.

Advantageously, a tangential-jet mixer, for example a Hartridge-Roughton mixer, is used in the process according to the present invention.

FIG. 1 is a scheme which shows a mixer of this type. This mixer 1 comprises a chamber 2 having at least two tangential admissions 3 and 4 via which the reagents enter separately (but at the same time), i.e. in this case the mixture formed in step (a) and the basic compound, and also an axial outlet 5 via which the reaction medium exits, and does so, preferably, toward a reactor (tank) placed in series after said mixer. The two tangential admissions are preferably located symmetrically and in opposing manner relative to the central axis of the chamber 2.

The chamber 2 of the tangential-jet, Hartridge-Roughton mixer used generally has a circular cross section and is preferably cylindrical in shape.

Each tangential admission tube may have an internal height (a) in cross section of from 0.5 to 80 mm.

This internal height (a) may be between 0.5 and 10 mm, in particular between 1 and 9 mm, for example between 2 and 7 mm. However, in particular on the industrial scale, it is preferably between 10 and 80 mm, in particular between 20 and 60 mm, for example between 30 and 50 mm.

The internal diameter of the chamber 2 of the tangential-jet, Hartridge-Roughton mixer employed may be between 3a and 6a, in particular between 3a and 5a, for example equal to 4a; the internal diameter of the axial outlet tube 5 may be between 1a and 3a, in particular between 1.5a and 2.5a, for example equal to 2a.

The height of the chamber 2 of the mixer may be between 1 a and 3a, in particular between 1.5 and 2.5a, for example equal to 2a.

The reaction performed in step (b) of the process leads to the formation of a precipitate, which is removed from the reactor and recovered to perform step (c).

In the case of the second variant, step (b′) is performed in a reactor of centrifugal type. A reactor of this type means rotary reactors using centrifugal force.

Examples of reactors of this type that may be mentioned include rotor-stator mixers or reactors, rotating-disk reactors (sliding-surface reactor), in which the reagents are injected under high shear into a confined space between the bottom of the reactor and a disk rotating at high speed, or alternatively reactors in which the centrifugal force mixes the liquids intimately as thin films. The Spinning Disc Reactor (SDR) or the Rotating Packed Bed reactor (RPB), described in patent application US 2010/0 028 236 A1, are included in this category. The reactor described in said patent application comprises a porous structure or packing, made of ceramic, metallic foam or plastic, of cylindrical shape, which rotates at high speed about a longitudinal axis. The reagents are injected into this structure and become mixed under the effect of high shear forces due to the centrifugal forces, which may reach several hundred g, created by the rotational motion of the structure. Mixing of the liquids in veins or very thin films thus makes it possible to achieve nanometric sizes.

The process according to the second variant of the invention may thus be performed by introducing into the abovementioned porous structure the mixture formed in step (a′).

The reagents thus introduced may be subjected to an acceleration of at least 10 g, more particularly of at least 100 g, and which may be, for example, between 100 g and 300 g.

Given their design, these reactors may be used with residence times of the reaction medium in their mixing zone (in the same sense as given above for the first variant) that are longer than for the first variant of the process, i.e. up to several seconds and in general not more than 10 s. Preferably, this residence time may be not more than 1 s, more particularly not more than 20 ms and even more particularly not more than 10 ms.

As for the preceding variant, step (b′) is preferably performed using a stoichiometric excess of basic compound and this step generally takes place at room temperature.

After step (b′), the precipitate obtained is removed from the reactor and recovered to perform the next step.

Step (c) or (c′) is a step of heating the precipitate in aqueous medium.

This heating may be performed directly on the reaction medium obtained after reaction with the basic compound or on a suspension obtained after separating the precipitate from the reaction medium, optional washing of the precipitate and placing the precipitate back in water. The temperature to which the medium is heated is at least 90° C. and even more particularly at least 100° C. It may be between 100° C. and 200° C. The heating operation may be performed by introducing the liquid medium into a closed chamber (closed reactor of the autoclave type). Under the temperature conditions given above, and in aqueous medium, it may be pointed out, by way of illustration, that the pressure in the closed reactor may range between a value greater than 1 bar (10⁵ Pa) and 165 bar (1.65×10⁷ Pa), preferably between 5 bar (5×10⁵ Pa) and 165 bar (1.65×10⁷ Pa). It is also possible to carry out the heating in an open reactor for temperatures in the vicinity of 100° C.

The heating can be carried out either under air or under an inert gas atmosphere, preferably nitrogen.

The duration of the heating may vary within wide limits, for example between 1 minute and 2 hours, these values being given purely as a guide.

The medium subjected to heating has a pH of at least 5. Preferably, this pH is basic, i.e. it is greater than 7 and more particularly at least 8.

Several heating operations may be performed. Thus, the precipitate obtained after the heating step and optionally a washing operation may be resuspended in water and then another heating operation may be performed on the medium thus obtained. This other heating operation is carried out under the same conditions as those which were described for the first.

The following step of the process may take place according to two variants.

According to a first variant, an additive which is chosen from anionic surfactants, nonionic surfactants, polyethylene glycols, carboxylic acids and salts thereof, and surfactants of the carboxymethylated fatty alcohol ethoxylate type is added to the reaction medium obtained from the preceding step.

As regards this additive, reference may be made to the teaching of the application WO 98/45212 and the surfactants described in this document may be used.

Surfactants of the anionic type that may be mentioned include ethoxycarboxylates, ethoxylated or propoxylated fatty acids, especially those of the Alkamuls® brand, sarcosinates of formula R—C(O)N(CH₃)CH₂COO⁻, betaines of formula RR′NH—CH₃—COO⁻, R and R′ being alkyl or alkylaryl groups, phosphate esters, especially those of the Rhodafac® brand, sulfates such as alcohol sulfates, alcohol ether sulfates and alkanolamide sulfate ethoxylates, sulfonates such as sulfosuccinates and alkylbenzene or alkylnaphthalene sulfonates.

Nonionic surfactants that may be mentioned include acetylenic surfactants, ethoxylated or propoxylated fatty alcohols, for example those of the Rhodasurf® or Antarox® brands, alkanolamides, amine oxides, ethoxylated alkanolamides, long-chain ethoxylated or propoxylated amines, for example those of the Rhodameen® brand, ethylene oxide/propylene oxide copolymers, sorbitan derivatives, ethylene glycol, propylene glycol, glycerol, polyglyceryl esters and ethoxylated derivatives thereof, alkylamines, alkylimidazolines, ethoxylated oils and ethoxylated or propoxylated alkylphenols, especially those of the Igepal® brand. Mention may also be made in particular of the products mentioned in WO 98/45212 under the brand names Igepal®, Dowanol®, Rhodamox® and Alkamide®.

As regards the carboxylic acids, use may in particular be made of aliphatic mono- or dicarboxylic acids and, among these, more particularly of saturated acids. Use may also be made of fatty acids and more particularly of saturated fatty acids. Mention may thus be made especially of formic, acetic, propionic, butyric, isobutyric, valeric, caproic, caprylic, capric, lauric, myristic, palmitic, stearic, hydroxystearic, 2-ethylhexanoic and behenic acids. Mention may be made, as dicarboxylic acids, of oxalic, malonic, succinic, glutaric, adipic, pimelic, suberic, azelaic and sebacic acids.

The salts of the carboxylic acids can also be used, in particular the ammonium salts.

Mention may more particularly be made, as example, of lauric acid and ammonium laurate.

Finally, it is possible to use a surfactant which is chosen from those of the carboxymethylated fatty alcohol ethoxylate type.

Product of the carboxymethylated fatty alcohol ethoxylate type is understood to mean the products composed of ethoxylated or propoxylated fatty alcohols comprising, at the chain end, a CH₂—COOH group.

These products can correspond to the formula:

R₁—O—(CR₂R₃—CR₄R₅—O)ₙ—CH₂—COON

in which R₁ denotes a saturated or unsaturated carbon chain, the length of which is generally at most 22 carbon atoms, preferably at least 12 carbon atoms; R₂, R₃, R₄ and R₅ can be identical and represent hydrogen or else R₂ can represent a CH₃ group and R₃, R₄ and R₅ represent hydrogen; and n is a non-zero integer which can range up to 50 and more particularly between 5 and 15, these values being inclusive. It should be noted that a surfactant can be composed of a mixture of products of the above formula for which R₁ can be saturated and unsaturated respectively or else products comprising both —CH₂—CH₂—O— and —C(CH₃)—CH₂—O— groups.

Another variant consists in first separating out the precipitate obtained from step (c) and then adding the surfactant additive to this precipitate.

The amount of surfactant used, expressed as a weight percentage of additive relative to the weight of the composition calculated as oxide, is generally between 5% and 100%, more particularly between 15% and 60%.

After the addition of the surfactant, the mixture obtained is preferably kept stirring for a time which may be of about one hour. The precipitate is then optionally separated from the liquid medium via any known means.

The precipitate separated out may optionally be washed, especially with aqueous ammonia.

In a final step of the process according to the invention, the recovered and optionally dried precipitate is then calcined. This calcination makes it possible to develop the crystallinity of the product formed and it can also be adjusted and/or chosen according to the subsequent temperature of use intended for the composition according to the invention, this being done while taking into account the fact that the specific surface area of the product decreases as the calcination temperature employed increases. Such a calcination is generally carried out under air but a calcination carried out, for example, under an inert gas or under a controlled atmosphere (oxidizing or reducing) is very clearly not excluded.

In practice, the calcination temperature is generally limited to a range of values of between 300 and 900° C. over a time that may be, for example, between 1 hour and 10 hours.

According to another variant of the process of the invention, the additional elements iron, cobalt, strontium, copper and manganese may be not added during the preparation of the composition as was described above, but they may be provided using the impregnation method. In this case, the composition derived from the calcination of the mixed oxide of zirconium and cerium is impregnated with a solution of a salt of the additional element and then subjected to another calcination under the same conditions as those given above.

The product derived from the calcination is in the form of a powder and, if necessary, it may be deaggregated or ground as a function of the size desired for the constituent particles of this powder.

The compositions of the invention may also optionally be shaped so as to be in the form of granules, beads, cylinders or honeycombs of variable sizes.

The compositions of the invention may be used as catalysts or catalyst supports. Thus, the invention also relates to catalytic systems comprising the compositions of the invention. For such systems, these compositions may thus be applied to any support usually used in the field of catalysis, i.e. especially thermally inert materials. This support may be chosen from alumina, titanium oxide, cerium oxide, zirconium oxide, silica, spinels, zeolites, silicates, crystalline silicoaluminum phosphates or crystalline aluminum phosphates.

The compositions may also be used in catalytic systems comprising a coating (wash coat) having catalytic properties and based on these compositions, on a substrate of, for example, the metal monolith type, for example FeCr alloy, or made of ceramic, for example of cordierite, silicon carbide, alumina titanate or mullite. The coating may itself also comprise a thermally inert material of the type such as those mentioned above. This coating is obtained by mixing the composition with this material, so as to form a suspension which may then be deposited on the substrate.

These catalytic systems and more particularly the compositions of the invention can have a great many applications. They are therefore particularly well-suited to, and thus usable in, the catalysis of various reactions, for instance dehydration, hydrosulfurization, hydrodenitrification, desulfurization, hydrodesulfurization, dehydrohalogenation, reforming, steam reforming, cracking, hydrocracking, hydrogenation, dehydrogenation, isomerization, dismutation, oxychlorination, dehydrocyclization of hydrocarbons or other organic compounds, oxidation and/or reduction reactions, the Claus reaction, the oxidation of gases derived from stationary sources and also the treatment of exhaust gases from internal combustion engines, demetallation, methanation, the shift conversion or catalytic oxidation of the soot emitted by internal combustion engines, such as diesel engines or petrol engines operating under lean burn conditions.

The catalytic systems and the compositions of the invention may be used as NOx traps or in an SCR process, i.e. an NOx reduction process in which this reduction is performed with ammonia or an ammonia precursor such as urea.

In the case of these uses in catalysis, the compositions of the invention are generally employed in combination with precious metals; they thus act as support for these metals. The nature of these metals and the techniques for the incorporation of the latter in the support compositions are well-known to a person skilled in the art. For example, the metals can be platinum, rhodium, palladium or iridium; they can in particular be incorporated in the compositions by impregnation.

Among the mentioned uses, the treatment of the exhaust gases of internal combustion engines (motor vehicle afterburning catalysis) constitutes a particularly advantageous application. For this reason, the invention also relates to a process for treatment of exhaust gases from internal combustion engines, which is characterized in that use is made, as catalyst, of a catalytic system as described above or of a composition according to the invention and as described above.

Examples will now be given.

### EXAMPLE 1

This example concerns a composition containing 80% zirconium and 20% cerium, these proportions being expressed as mass percentages of the oxides ZrO₂ and CeO₂.

The necessary amount of cerium nitrate and of zirconium nitrate is introduced into a stirred beaker. The mixture is then made up with distilled water so as to obtain 1 liter of a solution of nitrates at 120 g/l (expressed here and throughout the examples as oxide equivalent).

An aqueous ammonia solution (10 mol/l) is introduced into another stirred beaker and the mixture is then made up with distilled water, so as to obtain a total volume of 1 liter and a stoichiometric excess of ammonia of 40%, relative to the cations to be precipitated.

The two solutions prepared previously are maintained under continual stirring and are introduced continuously into a Hartridge-Roughton rapid mixer of the type in FIG. 1 and with an inlet height (a) of 2 mm. The pH on leaving the mixer is 9.25. The flow rate of each of the reagents is 30 l/h and the residence time is 12 ms.

The suspension of precipitate thus obtained is placed in a stainless-steel autoclave equipped with a stirring rotor. The temperature of the medium is maintained at 150° C. for 2 hours with stirring.

33 grams of lauric acid are added to the suspension thus obtained. The suspension is kept stirred for 1 hour.

The suspension is then filtered through a Büchner funnel and the filtered precipitate is then washed with aqueous ammonia solution.

The product obtained is then maintained in a steady stage at 700° C. for 4 hours and then deaggregated in a mortar.

### COMPARATIVE EXAMPLE 2

This example relates to the same composition as that of Example 1.

The process begins with the same reagents, and 1 liter of a solution of cerium and zirconium nitrates is prepared.

An aqueous ammonia solution (10 mol/l) is introduced into a stirred reactor and the mixture is then made up with distilled water, so as to obtain a total volume of 1 liter and a stoichiometric excess of ammonia of 40%, relative to the nitrates to be precipitated.

The solution of nitrates is introduced into the reactor with continual stirring for 1 hour. After the precipitation, the process is then performed in the same manner as in Example 1.

The characteristics of the products obtained in the examples are given in Tables 1 and 2 below.

TABLE 1

| | Specific surface area S_{BET} (m²/g) after calcination | | |
|---|---|---|---|
| | for 4 hours at | | |
| | 900° C. | 1000° C. | 1100° C. |
| 1 | 56 | 39 | 14 |
| 2, comparative | 47 | 33 | 11 |

TABLE 2

| | | Amount of O₂ that | Amount of O₂ |
|---|---|---|---|
| | Maximum | is labile between | that is labile |
| | reducibility | 200 and 400° C. | between 200 and |
| | temperature (° C.) | (mL/g) | 450° C. (mL/g) |
| | 1000° C. ⁽²⁾ | 1000° C. ⁽²⁾ | 1000° C. ⁽²⁾ |
| 1 | 559 | 0.7 | 1.2 |
| 2, comparative | 597 | 0.4 | 0.8 |

⁽²⁾ This temperature is that to which the composition was first subjected, for 4 hours, before the reducibility measurement.

It should be noted that the products of Examples 1 and 2 are in the form of a solid solution after calcination for 4 hours at 900° C. or at 1000° C.

FIG. 2 gives the curves obtained by performing the reducibility measurement described above. The temperature is given on the x-axis and the value of the measured signal is given on the y-axis. The maximum reducibility temperature is that which corresponds to the maximum peak height of the curve. The figure gives the curves obtained for the compositions of Example 1 (curve with the peak to the extreme left of the figure) and Comparative Example 2 (curve with the peak to the extreme right).

1. A composition consisting essentially of a mixed oxide of zirconium and cerium, with a zirconium oxide content of at least 45% by mass, wherein the composition exhibits, after calcination at 1000° C. for 4 hours, a specific surface area of at least 25 m²/g and an amount of oxygen that is mobile between 200° C. and 400° C. of at least 0.5 ml O₂/g.

2. The composition as claimed in claim 1, wherein the composition exhibits an amount of oxygen that is mobile between 200° C. and 450° C. of at least 0.9 ml O₂/g.

3. The composition as claimed in claim 1, wherein the composition has a zirconium oxide content of at least 60%.

4. The composition as claimed in claim 1, wherein the composition exhibits, after calcination at 1000° C. for 4 hours, an amount of oxygen that is mobile between 200° C. and 400° C. of at least 0.6 ml O₂/g.

5. The composition as claimed in claim 1, wherein the composition exhibits, after calcination at 1000° C. for 4 hours, a specific surface area of at least 30 m²/g.

6. The composition as claimed in claim 1, wherein the composition exhibits, after calcination at 1100° C. for 4 hours, a specific surface area of at least 8 m²/g.

7. The composition as claimed in claim 1, wherein the composition exhibits a maximum reducibility temperature of not more than 580° C. after calcination at 1000° C. for 4 hours.

8. The composition as claimed in claim 1, further comprising one or more additional elements chosen from the group consisting of iron, cobalt, strontium, copper and manganese.

9. The composition as claimed in claim 1, wherein the composition is deaggregatable by an ultrasonication treatment and, after this treatment, is in the form of particles with a mean diameter (d₅₀) of not more than 10 μm.

10. A process for preparing a composition as claimed in claim 1, wherein the process comprises:
(a) forming a liquid mixture comprising compounds of cerium, zirconium and, optionally, an additional element;
(b) continuously reacting the liquid mixture either (i) in a reactor with a basic compound, the residence time of the reaction medium in the mixing zone of the reactor being not more than 100 milliseconds or (ii) in a centrifugal reactor with a basic compound, the residence time of the reaction medium in the mixing zone of the centrifugal reactor being not more than 10 seconds, to produce a precipitate at the reactor outlet;
(c) heating said precipitate in aqueous medium, the medium being maintained at a pH of at least 5;
(d) adding an additive chosen from anionic surfactants, nonionic surfactants, polyethylene glycols, carboxylic acids and salts thereof, and surfactants of the carboxymethylated fatty alcohol ethoxylate type to the heated precipitate to produce a solid;
(e) calcining the solid.

11. (canceled)

12. The process as claimed in claim 10, wherein the compounds of cerium, zirconium and, optionally, the additional element comprise compounds chosen from nitrates, sulfates, acetates, chlorides and ceric ammonium nitrate.

13. The process as claimed in claim 10, wherein the heating of the precipitate in step (c) is performed at a temperature of at least 100° C.

14. The process as claimed in claim 10, wherein the residence time in the reactor is not more than 20 milliseconds.

15. A catalytic system comprising a composition as claimed in claim 1.

16. A process for treating exhaust gases of internal combustion engines, the process comprising contacting an exhaust gas of an internal combustion engine with a composition as claimed in claim 1, such that the gas is treated.

17. The composition as claimed in claim 1, wherein the composition exhibits an amount of oxygen that is mobile between 200° C. and 450° C. of at least 1 ml O₂/g.

18. The composition as claimed in claim 1, wherein the composition has a zirconium oxide content of at least 70%.

19. The composition as claimed in claim 1, wherein the composition exhibits, after calcination at 1000° C. for 4 hours, a specific surface area of at least 35 m²/g.

20. The composition as claimed in claim 1, wherein the composition exhibits, after calcination at 1100° C. for 4 hours, a specific surface area of at least 10 m²/g.

21. The composition as claimed in claim 1, wherein the composition exhibits a maximum reducibility temperature of not more than 570° C. after calcination at 1000° C. for 4 hours.
